(19) United States
(12) Patent Application Publication
(10) Pub. No.: US 2009/0070384 A1
(43) Pub. Date: Mar. 12, 2009

(54) METHOD AND APPARATUS TO UPDATE METADATA OF CONTENTS

(75) Inventor: Ju-hee SEO, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/041,835

(22) Filed: Mar. 4, 2008

(30) Foreign Application Priority Data
Sep. 6, 2007 (KR) 2007-90579

(51) Int. Cl. G06F 12/00

(52) U.S. Cl. 707/200; 707/E17.001

(57) ABSTRACT

A method and apparatus to update metadata of one or more contents includes selecting content having metadata to be updated from a plurality of contents, determining whether or not to update second metadata that is metadata of the selected content with reference to first metadata that is metadata of at least one unselected content of the plurality of contents, and selectively updating the second metadata based on the determination.

### CROSS-REFERENCE TO RELATED APPLICATIONS

This application claims priority under 35 U.S.C. §119(a) from Korean Patent Application No. 10-2007-0090579, filed on Sep. 6, 2007, in the Korean Intellectual Property Office, the disclosure of which is incorporated herein in its entirety by reference.

### BACKGROUND OF THE INVENTION

1. Field of the Invention

The present general inventive concept relates to a method and apparatus to update metadata of contents.

2. Description of the Related Art

As portable devices such as portable multimedia players (PMP), MPEG-1 Audio layer-3 (MP3) players, and the like are popularized, demands for contents increase and also the types and amounts of contents are drastically increasing.

The contents may include metadata, which is data about data, or information known about the data in order to provide access to the data. Metadata usually includes information about an intellectual content of the data, digital representation data, and security or rights management information of the data.

For example, metadata on audio data may include a running time, a title, a musician's name, or the like thereof.

The metadata may include more detailed data, for example, data on family relations, previous albums, a biography, or the like of a musician as well as the musician's name.

Since old contents cannot reflect the latest data, metadata of old contents may include a small amount of data. However, new data cannot be added to metadata unless a user adds new metadata to contents.

That is, a user should manually add metadata to contents in order to obtain more data by means of the added metadata.

### SUMMARY OF THE INVENTION

The present general inventive concept provides an apparatus and method of updating metadata of contents to automatically update metadata of contents with new data.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of updating metadata of contents, the method including selecting content having metadata to be updated from a plurality of contents, determining whether or not to update second metadata that is metadata of the selected content with reference to first metadata that is metadata of at least one unselected content of the plurality of contents, and selectively updating the second metadata based on the determination.

The determining may be determined whether or not to update the second metadata based on whether or not data related to data included in the second metadata is included in the first metadata.

The updating may include collecting the data related to the data included in the second metadata from the first metadata, and updating the second metadata using the collected data.

Each of the first and second metadata may include a plurality of fields classified depending on kinds of data included in the metadata, and in the updating of the second metadata, if the first metadata comprises a field that is not included in the second metadata, the field is added to the second metadata and data corresponding to the added field is added to the added field using the collected data.

The method of updating metadata of contents may further include analyzing the selected content; and generating the second metadata using data obtained by the analyzing.

In the analyzing of the selected content, a text included in the selected content may be analyzed.

The method of updating metadata of contents may further include updating the updated metadata to the latest format.

The method of updating metadata of contents may further include changing formats of the first or second metadata to the same format when the first metadata has a format different from the second metadata.

In the collecting of the data, the data may be collected from the metadata of the same kind of contents as the selected content or different kinds of contents from the selected content.

The plurality of contents may be included in at least one of a hard disk, a portable storage device, and a storage device of a server.

The foregoing and/or other aspects and utilities of the present general inventive concept may also be achieved by providing an apparatus to update metadata of contents, including a selection unit to select a content having metadata to be updated from a plurality of contents, an update determining unit to determine whether or not to update second metadata that is metadata of the selected content with reference to first metadata that is metadata of at least one unselected content of the plurality of contents, and a metadata update unit to selectively update the second metadata based on the determination.

The metadata update unit may include a data collecting unit to collect the data related to the data included in the second metadata from the first metadata, and an update unit to update the second metadata using the collected data.

The apparatus may further include a content analysis unit to analyze the selected content, and a metadata generating unit to generate the second metadata using data obtained by the analyzing.

The apparatus may further include a metadata reconfiguring unit to update the updated metadata to the latest format.

The apparatus may further include a format change unit to change formats of the first and second metadata to the same format when the first metadata has a format different from the second metadata.

The foregoing and/or other aspects and utilities of the present general inventive concept may also be achieved by providing a computer-readable recording medium having a computer-readable program for executing the method including selecting content having metadata to be updated from a plurality of contents, determining whether or not to update second metadata that is metadata of the selected content with reference to first metadata that is metadata of at least one unselected content of the plurality of contents, and selectively updating the second metadata based on the determination.

The foregoing and/or other aspects and utilities of the present general inventive concept may also be achieved by providing an apparatus to update metadata of a content, including a storage unit to store a plurality of contents including a first content and a second content; and an updating unit to update second metadata of the second content with first meta data of the first content.

The foregoing and/or other aspects and utilities of the present general inventive concept may also be achieved by providing an apparatus to update metadata of a content, including a selection unit to select one of a plurality of contents, and an updating unit to update second metadata of the selected content with first metadata of second metadata of an unselected content among the plurality of contents.

The foregoing and/or other aspects and utilities of the present general inventive concept may also be achieved by providing an apparatus to update metadata of a content, including a storage unit to store a plurality of contents including a first content and a second content, a selection unit to select the second content among the plurality of contents, and an updating unit to update second metadata of the selected second content with first metadata of the unselected first content among the plurality of contents.

The foregoing and/or other aspects and utilities of the present general inventive concept may also be achieved by providing an apparatus to update metadata of a content, including a storage unit to store a plurality of contents including a first content and a second content, a selection unit to select the second content among the plurality of contents, an update determining unit to determine whether to update second metadata of the selected content according to first metadata of the unselected first content among the plurality of contents, and an updating unit to update second metadata of the selected second content with first metadata of the unselected first content among the plurality of contents.

The first metadata may have a first format, the second metadata may have a second format, and the apparatus may include a format change unit to change the first format of the first metadata to the second format of the second metadata.

The first content and the second content may be stored in a same directory of the storage unit.

The update unit may automatically update the second metadata with the first metadata according to the determination of the update determining unit.

The update determining unit may determine whether to update the second metadata according to a difference between the first metadata and the second metadata.

The first metadata of the first content may be the same metadata of another content of the plurality of contents.

The second metadata of the second content may be the same metadata of a second number of another contents of the plurality of contents, the first metadata of the first content may have the same metadata of a first number of another contents of the plurality of contents, and the first number of another contents may be equal to or greater than the second number of another contents.

The storage unit may receive the first content from an external device to be included in the plurality of contents.

The storage unit may be disposed in an external device connectable to the apparatus through a network to store the plurality of contents.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A is a block diagram illustrating an apparatus to update metadata of contents according to an embodiment of the present general inventive concept;

FIG. 1B is a block diagram illustrating an apparatus to update metadata of contents according to another embodiment of the present general inventive concept;

FIG. 2 is a view illustrating an operation of an update determining unit according to an embodiment of the present general inventive concept;

FIG. 3 is a block diagram illustrating a metadata update unit according to an embodiment of the present general inventive concept; and

FIG. 4 is a flowchart illustrating a method of updating metadata of contents according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

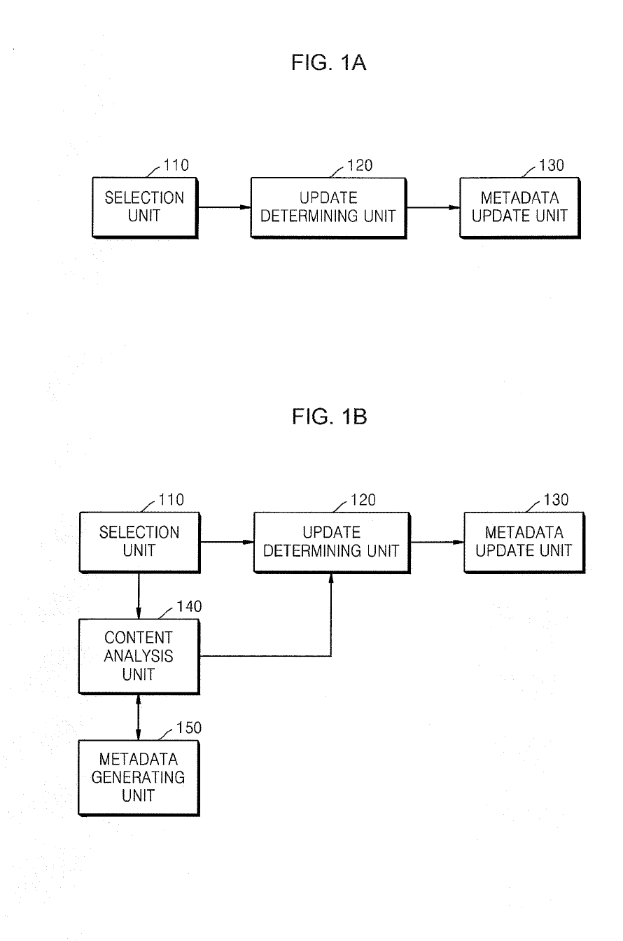

FIG. 1A is a block diagram illustrating an apparatus to update metadata of one or more contents according to an embodiment of the present general inventive concept.

Referring to FIG. 1A, the apparatus to update the metadata of contents according to the current embodiment of the present general inventive concept includes a selection unit 110, an update determining unit 120, and a metadata update unit 130.

The selection unit 110 selects a content having metadata to be updated from a plurality of contents.

Here, the content may include at least one of video, audio, and image data as content data, and may include the metadata regarding the content data.

Also, the plurality of contents may be included in a same directory of a storage device such as a hard disk of a computer. For example, audio files such as A.mp3, B.mp3, and C.mp3 may be included in a MUSIC directory of a computer hard disk as the plurality of contents, and the selection unit 110 may select A.mp3, one of the plurality of contents.

Here, each of A.mp3, B.mp3, and C.mp3 may include metadata and content data as illustrated in Table 1.

TABLE 1

| | |
|---|---|
| Metadata | Content data |

However, the present general inventive concept is not limited to this file configuration, and the content data may be included in front of metadata in other file configurations.

Meanwhile, the selection unit 110 may select one of a plurality of contents that are included in different directories of a predetermined storage device. Here, the predetermined storage device includes at least one of a hard disk, a portable storage device, a solid state device (SSD), and a storage device of a server.

The update determining unit 120 determines whether to update second metadata that is metadata of the content selected by the selection unit 110 with reference to first metadata that is metadata of at least one unselected content of the plurality of contents.

For example, when the audio files, such as A.mp3, B.mp3, and C.mp3, are included in a MUSIC directory and the selection unit 110 selects A.mp3 in order to update metadata thereof, the update determining unit 120 determines whether to update metadata of A.mp3 with reference to metadata of B.mp3 and C.mp3.

In this case, the update determining unit 120 determines to update the metadata of A.mp3 when data related to metadata of A.mp3 is included in metadata of B.mp3 and C.mp3.

According to an embodiment of the present general inventive concept, A.mp3, B.mp3, and C.mp3 may be included in MUSIC 1, MUSIC 2, and MUSIC 3 directories, respectively, and the update determining unit 120 may determine whether to update metadata of A.mp3 with reference to metadata of B.mp3 and C.mp3 that is included in different directories.

In addition, when determining whether or not to update metadata, the update determining unit 120 may refer to metadata of contents that are included in directories of other devices connected to the update determining unit 120 through a network as well as directories of a device, in which the apparatus to update metadata of contents is installed in, according to the current embodiment of the present general inventive concept.

For example, the update determining unit 120 may determine whether or not to update metadata of A.mp3 that is included in a device, in which the apparatus to update metadata of contents is installed in, according to the current embodiment of the present invention with reference to metadata of contents stored in a server connected through a network.

In this case, the update determining unit 120 may request the server to check whether or not data for updating metadata of A.mp3 is included in the server while transferring metadata of A.mp3 to the server. When data for updating metadata of A.mp3 is included in the server, the server informs the apparatus to update metadata of contents according to the current embodiment of the present invention that the data is included therein, and the update determining unit 120 determines to update metadata of A.mp3.

Here, a condition for selecting a directory having contents to be referred to can be set by a user.

For example, when a user determines an update condition to refer to files that are included in a MUSIC 2 directory, the update determining unit 120 may determine whether to update metadata of A.mp3 with reference to only metadata of contents that are included in MUSIC 2 or with reference to metadata of contents that are included in one of directories or in an external device connected to the network.

When determining whether to update metadata, the update determining unit 120 may refer to metadata of different kinds of contents from the selected contents as well as metadata of the same kinds of contents as the selected contents.

For example, when the selection unit 110 selects A.mp3 from the audio files such as A.mp3, B.mp3 and C.mp3, and a video file such as D.mp4, the update determining unit 120 may determine whether to update metadata of A.mp3 with reference to D.mp4 as well as metadata of B.mp3 and C.mp3.

When a format of metadata (hereinafter, referred to as first metadata) of unselected contents is different from a format of metadata (hereinafter, referred to as second metadata) of selected content, the format of the first metadata may be changed to the format of the second metadata, and then it can be determined whether or not to update the second metadata with reference to the first metadata with the changed format. Here, the format of the second metadata may be changed to the format of the first metadata or the formats of the first and second metadata may be changed to a third format.

The format may be changed because metadata should have the same format in order to compare data included in the first and second metadata with each other.

For example, when the first metadata has a markup language format such as a hyper text markup language (HTML), an extensible markup language (XML), or the like and the second metadata has a binary format, the format of the first metadata may be changed to the binary format of the second metadata.

The apparatus to update metadata of contents according to the current embodiment of the present invention may further include a format change unit (not illustrated) to change one or more formats of metadata into a same format.

However, the format change unit may be omitted when the update determining unit 120 can read metadata of various types of formats such as a mark up language format, a text format, a binary format, or the like.

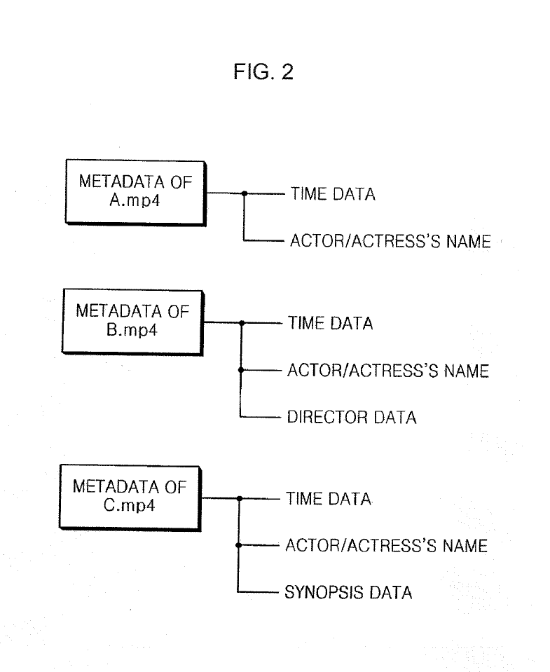

The update determining unit 120 may determine whether or not to update metadata depending on whether data related to the second metadata is included in the first metadata or not. The update determining unit 120 will be explained later with reference to FIG. 2.

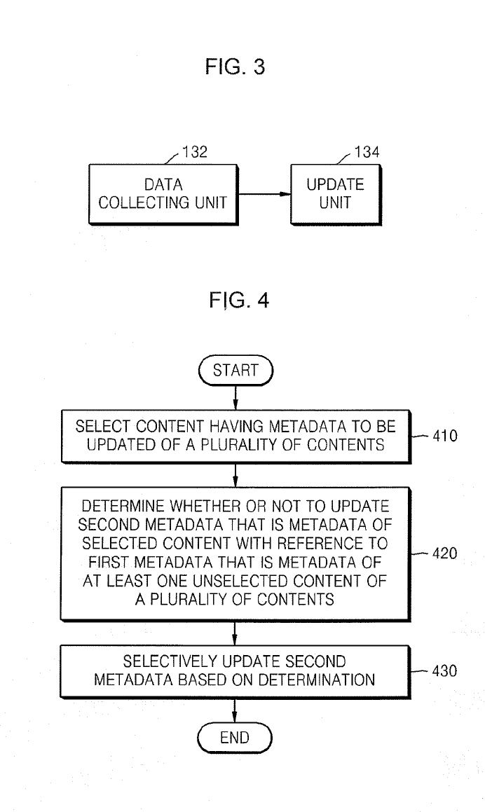

The metadata update unit 130 selectively updates second metadata that is metadata of the content selected by the selection unit 110, based on determination of the update determining unit 120. The metadata update unit 130 will be explained later with reference to FIG. 3.

FIG. 1B is a block diagram illustrating an apparatus to update metadata of one or more contents according to another embodiment of the present general inventive concept.

Referring to FIG. 1B, the apparatus to update the metadata of contents according to another embodiment of the present general inventive concept includes a selection unit 110, an update determining unit 120, a metadata update unit 130, .a content analysis unit 140, and metadata generating unit 150.

Since operations of the units 110 to 130 of FIG. 1B are the same as the operations of the units 110 to 130 of FIG. 1A, descriptions on the units 110 to 130 are omitted.

The content analysis unit 140 analyzes a content selected by the selection unit 110

The metadata generating unit 150 generates metadata of the selected content using data obtained by the content analysis unit 140.

FIG. 2 is a view illustrating an operation of the update determining unit 120 of FIGS. 1A and 1B according to an embodiment of the present general inventive concept.

FIG. 2 illustrates metadata of mp4 files that are video files according to an embodiment of the present general inventive concept. Referring to FIG. 2, the metadata may include a plurality of fields classified depending on kinds of data included in the metadata.

Referring to FIG. 2, metadata of A.mp4 includes a time data field and an actor/actress's name field, metadata of B.mp4 includes a time data field, an actor/actress data field, and a director data field, and metadata of C.mp4 includes a time data field, an actor/actress data field, and a synopsis data field.

Here, B.mp4 and C.mp4 further include the director data field and the synopsis data field, respectively, as compared with A.mp4, and each include the actor/actress data field instead of the actor/actress's name field of A.mp4. While only the actor/actress's name is included in the actor/actress's name field, data related to the actor/actress including the actor/actress's name is further included in the actor/actress data field.

When the selection unit 110 selects A.mp4, the update determining unit 120 checks whether or not data related to second metadata that is metadata of A.mp4 is included in first metadata that is metadata of B.mp4 and C.mp4.

For example, when a name of an actor (actress) is included in the actor/actress's name field of the metadata of A.mp4, the update determining unit 120 checks whether or not data related to the actor is included in the metadata of B.mp4 and C.mp4. Then, when the data is included in the metadata of B.mp4 or C.mp4, the update determining unit 120 may determine to update the metadata of A.mp4 with the data included in the metadata of B.mp4 and C.mp4.

That is, when data of family relations, biography, and filmography of the actor is included in the actor/actress data field of the metadata of B.mp4 and C.mp4, the update determining unit 120 may determine to update the second metadata with respect to the first metadata.

Here, the update determining unit 120 may analyze configurations of the first and second metadata in order to check whether or not data related to the second metadata is included in the first metadata and determine whether or not to update the second metadata based on the analysis result.

Meanwhile, metadata may not exist in a content selected by the selection unit 110 from the plurality of contents. In this case, metadata may be generated in the selected content.

When metadata of A.mp4 does not exist, contents of A.mp4 may be analyzed to generate metadata. For example, when a caption file is included in A.mp4, the caption file is analyzed to generate cast data, director data, film production data, or the like. In addition, when a picture of A.mp4 that is a video file is reproduced on a screen, new metadata may be generated in the manner of recognizing a logo of a film production or a face contour of an actor/actress reproduced on the screen.

FIG. 3 is a block diagram illustrating the metadata update unit 130 according to an embodiment of the present general inventive concept.

Referring to FIG. 3, the metadata update unit 130 according to the current embodiment of the present general inventive concept includes a data collecting unit 132 and an update unit 134.

The data collecting unit 132 collects data related to metadata (hereinafter, referred to as second metadata) of a content that is selected by the selection unit 110 from metadata (hereinafter, referred to as first metadata) of at least one content that is not selected by the selection unit 110 based on determination performed by the update determining unit 120.

For example, in order to update metadata of A.mp4 illustrated in FIG. 2, when data of family relations, biography, and filmography of an actress or actor is included in the actor/actress data field of the metadata of B.mp4 and C.mp4 in relation to the actor's name of the actor/actress's name field of the metadata of A.mp4, the data collecting unit 132 collects the data related to the actor.

Here, the data collecting unit 132 may collect data for an update process from metadata of contents that are included in other devices connected to a network as well as metadata of contents that are included in a device, in which the apparatus to update metadata of contents is installed, according to the embodiment of the present general inventive concept as illustrated in FIGS. 1A, 1B and 3.

The update unit 134 updates the second metadata using the data collected by the data collecting unit 132.

Here, when the first metadata includes a field that does not exist in the second metadata, the update unit 134 may update the second metadata by adding the field of the first metadata to the second metadata and adding data corresponding to the added field using the data collected by the data collecting unit 132.

For example, when the first metadata includes four fields and the second metadata includes three fields of the four fields of the first metadata, the update unit 134 may update the second metadata to the four-field configuration by adding one field thereto. However, in the updating of the second metadata, if a field that does not exist in the second metadata is included in the first metadata, the update unit 134 may add the field to the second metadata, and then, if data corresponding to the added field is not included in the first metadata, the update unit 134 may delete the added field from the second metadata.

When the first metadata includes more fields than the second metadata, the update unit 134 checks whether or not data related to the second metadata is included in the first metadata, and the update unit 134 may update by checking whether or not data related to the second metadata is included in the first metadata, and only when it is estimated that the data of the first metadata is included in the field that is not included in the second metadata, adding the field to the second metadata and adding the data to the added field.

For example, when A.mp4 and C.mp4 are video files of a movie of a first episode and the movie of a second episode, respectively, in FIG. 2, and synopsis data of the first episode of the movie is included in the synopsis data field of C.mp4, the update unit 134 may add the synopsis data field to the metadata of A.mp4 and add data included in the synopsis data field of C.mp4 to the added synopsis data field of A.mp4.

Even though the synopsis data field, which is included in C.mp4, is not included in A.mp4, when the synopsis data of the movie of the first episode is not included in the synopsis data field, the synopsis data field is not added to the second metadata. Here, keyword data for representing the synopsis data related to the movie of the first episode may be further added to the synopsis data of the movie of the first episode that is included in the synopsis data field of C.mp4 such that the synopsis data can be easily searched.

In order to maintain accuracy and correctness of data to be updated, when data collected from a plurality of pieces of metadata is contradictory to each other, the update unit 134 may use only data included in a larger number of metadata than a small number of metadata to update the metadata of the small number of the metadata.

That is, when the actor is represented as “married” in the metadata of A.mp4 and B.mp4, and the actor is represented as “unmarried” in the metadata of C.mp4, data on the actor is updated to “married”.

In the present embodiment, the updated second metadata may be updated to the latest format such that the updated metadata can be read by more devices. Here, the latest format should be compatible with formats of a previous version.

In files including contents and metadata, metadata is usually located first and contents are located later. When updated metadata is stored in the same region of a file as the metadata was stored before the update, the metadata may overlap with some of the contents due to an increased volume of the updated metadata. In order to prevent this problem, an operation of repositioning contents and metadata in a file may further performed.

FIG. 4 is a flowchart illustrating a method of updating metadata of contents according to an embodiment of the present general inventive concept.

In operation 410, a content having metadata to be updated from a plurality of contents is selected.

In operation 420, it is determined whether or not to update second metadata that is metadata of the selected content with reference to first metadata that is metadata of at least one unselected content among the plurality of contents.

In operation 430, the second metadata is selectively updated based on the determination in operation 420.

The embodiments of the present general inventive concept can be written as computer programs and can be implemented in general-use digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to the present general inventive concept, metadata of contents can be automatically updated with new data by selecting content having metadata to be updated from a plurality of contents, determining whether or not to update second metadata that is metadata of the selected content with reference to first metadata that is metadata of at least one unselected content of the plurality of contents, and selectively updating the second metadata based on the determination.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of updating metadata of contents, the method comprising:
selecting content having metadata to be updated from a plurality of contents;
determining whether to update second metadata that is metadata of the selected content with reference to first metadata that is metadata of at least one unselected content of the plurality of contents; and
selectively updating the second metadata based on the determination.

2. The method of claim 1, wherein the determining of whether to update the second metadata comprises determining whether data related to data included in the second metadata is included in the first metadata.

3. The method of claim 2, wherein the updating comprises:
collecting the data related to the data included in the second metadata from the first metadata; and
updating the second metadata using the collected data.

4. The method of claim 3, wherein:
each of the first and second metadata comprises a plurality of fields classified depending on kinds of data included in the metadata, and
the updating of the second metadata comprises if the first metadata comprises a field that is not included in the second metadata, adding the field to the second metadata and adding data corresponding to the added field to the added field using the collected data.

5. The method of claim 1, further comprising:
analyzing the selected content; and
generating the second metadata using data obtained by the analyzing.

6. The method of claim 5, wherein a text included in the selected content is analyzed.

7. The method of claim 1, further comprising:
updating the updated metadata to the latest format.

8. The method of claim 2, further comprising:
changing formats of the first or second metadata to the same format when the first metadata has a format different from the second metadata.

9. The method of claim 3, wherein the data is collected from the metadata of the same kind of contents as the selected content or different kinds of contents from the selected content.

10. The method of claim 1, wherein the plurality of contents are included in at least one of a hard disk, a portable storage device, a solid state device, and a storage device of a server.

11. An apparatus to update metadata of contents, comprising:
a selection unit to select a content having metadata to be updated from a plurality of contents;
an update determining unit to determine whether to update second metadata that is metadata of the selected content with reference to first metadata that is metadata of at least one unselected content of the plurality of contents; and
a metadata update unit to selectively update the second metadata based on the determination.

12. The apparatus of claim 11, wherein the update determining unit determines whether to update the second metadata according to a determination of whether data related to data included in the second metadata is included in the first metadata.

13. The apparatus of claim 11, wherein the metadata update unit comprises:
a data collecting unit to collect the data related to the data included in the second metadata from the first metadata; and
an update unit to update the second metadata using the collected data.

14. The apparatus of claim 13, wherein:
the first and second metadata comprise a plurality of fields classified depending on kinds of data included in the metadata; and
when the first metadata comprises a field that does not exist in the second metadata, the update unit adds the field to the second metadata and adds data corresponding to the added field using the collected data.

15. The apparatus of claim 11, further comprising:
a content analysis unit to analyze the selected content; and
a metadata generating unit to generate the second metadata using data obtained by the analyzing.

16. The apparatus of claim 15, wherein the content analysis unit analyzes a text included in the selected content.

17. The apparatus of claim 11, further comprising:
a metadata reconfiguring unit to update the updated metadata to the latest format.

18. The apparatus of claim 11, further comprising:
a format change unit to change one or more formats of the first and second metadata to the same format when the first metadata has a format different from the second metadata.

19. The apparatus of claim 13, wherein the data collecting unit collects the data from the metadata of the same kind of contents as the selected content or a different kind of contents from the selected content.

20. The apparatus of claim 11, wherein the plurality of contents are included in at least one of a hard disk, a portable storage device, a solid state device, and a storage device of a server.

21. A computer-readable recording medium having computer-readable codes as a computer-readable program to execute a method comprising:
selecting content having metadata to be updated from a plurality of contents;
determining whether to update second metadata that is metadata of the selected content with reference to first metadata that is metadata of at least one unselected content of the plurality of contents; and
selectively updating the second metadata based on the determination.

22. An apparatus to update metadata of a content, comprising:
a storage unit to store a plurality of contents including a first content and a second content; and
an updating unit to update second metadata of the second content with first meta data of the first content.

23. An apparatus to update metadata of a content, comprising:
a selection unit to select one of a plurality of contents; and
an updating unit to update second metadata of the selected content with first metadata of an unselected content among the plurality of contents.

24. An apparatus to update metadata of a content, comprising:
a storage unit to store a plurality of contents including a first content and a second content;
a selection unit to select the second content among the plurality of contents; and
an updating unit to update second metadata of the selected second content with first metadata of the unselected first content among the plurality of contents.

25. An apparatus to update metadata of a content, comprising:
a storage unit to store a plurality of contents including a first content and a second content;
a selection unit to select the second content among the plurality of contents;
an update determining unit to determine whether to update second metadata of the selected content according to first metadata of the unselected first content among the plurality of contents; and
an updating unit to update second metadata of the selected second content with first metadata of the unselected first content among the plurality of contents, based on the determination of the update determining unit.

26. The apparatus of claim 25, wherein the first metadata has a first format, the second metadata has a second format, and the apparatus comprises a format change unit to change the first format of the first metadata to the second format of the second metadata.

27. The apparatus of claim 25, wherein the update unit automatically updates the second metadata with the first metadata according to the determination of the update determining unit.

28. The apparatus of claim 25, wherein the update determining unit determines whether to update the second metadata according to a difference between the first metadata and the second metadata.

29. The apparatus of claim 25, wherein the storage unit receives the first content from an external device to be included in the plurality of contents.

30. The apparatus of claim 25, wherein the storage unit is disposed in an external device connectable to the apparatus to store the plurality of contents.
